(19) United States
(12) Patent Application Publication
(10) Pub. No.: US 2017/0278453 A1
(43) Pub. Date: Sep. 28, 2017

(54) HEAD MOUNT DISPLAY

(71) Applicant: KYOCERA Corporation, Kyoto-shi (JP)

(72) Inventors: Yoshiteru KUROSAKI, Yokohama-shi (JP); Jun MATSUZAWA, Kawasaki-shi (JP); Kouichirou FUJIHARA, Yokohama-shi (JP); Keisuke OKADA, Yokohama-shi (JP); Tomohiro DEGAWA, Tokyo (JP); Susumu OZAWA, Ebina-shi (JP); Shingo ITO, Kawasaki-shi (JP)

(21) Appl. No.: 15/468,420

(22) Filed: Mar. 24, 2017

(30) Foreign Application Priority Data
Mar. 28, 2016 (JP) 2016-064385

(51) Int. Cl. G09G 3/20; G06F 1/16

(52) U.S. Cl. CPC G09G 3/2096; G06F 1/1656; G06F 1/163; G09G 3/02

(57) ABSTRACT

A head mount display includes a display, a communication unit, and a controller configured to execute a first application on the basis of data acquired from outside. When receiving emergency information through the communication unit during execution of the first application, the controller is configured to execute a second application for displaying evacuation information on the display, after a non-display state in which information is not displayed on the display.

### CROSS-REFERENCE TO RELATED APPLICATION(S)

The present application claims priority to and incorporates by reference the entire contents of Japanese Patent Application No. 2016-064385 filed in Japan on Mar. 28, 2016.

### BACKGROUND

### 1. Field

The present application relates to a head mount display.

### 2. Description of the Related Art

Conventionally, there have been display devices configured to be mounted to a head.

### SUMMARY

A head mount display includes a display, a communication unit, and a controller configured to execute a first application on the basis of data acquired from outside. When receiving emergency information through the communication unit during execution of the first application, the controller is configured to execute a second application for displaying evacuation information on the display, after a non-display state in which information is not displayed on the display.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view of a schematic configuration of a head mount display according to embodiments;

FIG. 2 is a view illustrating an example of a positioning location of an interface according to embodiments;

FIG. 3 is a view illustrating an example of a positioning location of an interface according to embodiments;

FIG. 4 is a view illustrating an example of an opening direction of an interface according to embodiments;

FIG. 5 is a view illustrating another example of a positioning location and an opening direction of an interface according to embodiments;

FIG. 6 is a view illustrating another example of a positioning location and an opening direction of an interface according to embodiments;

FIG. 7 is a block diagram illustrating an example of a functional configuration of a head mount display according to embodiments;

FIG. 8 is a diagram illustrating an example of processing by a controller according to embodiments;

FIG. 9 is a flowchart illustrating an example of processing performed by a head mount display according to embodiments;

FIG. 10 is a diagram illustrating an example of processing by a controller according to other embodiments; and

FIG. 11 is a flowchart illustrating an example of processing performed by a head mount display according to other embodiments.

### DETAILED DESCRIPTION OF THE PREFERRED EMBODIMENTS

The display devices have been required to have further improved usability. Embodiments of a head mount display according to the present application will be described in detail with reference to the drawings. A user of the head mount display according to the present application can connect for example a cartridge to the head mount display so that the head mount display reads specific content from the cartridge, and various services can be provided through the head mount display. The cartridge connectable to the head mount display may be provided from various indoor or outdoor facilities, from which services can be provided through the head mount display, such as a business park, a mall, a fashion mall, a park, an amusement arcade, a high-technology park, and a residential facility.

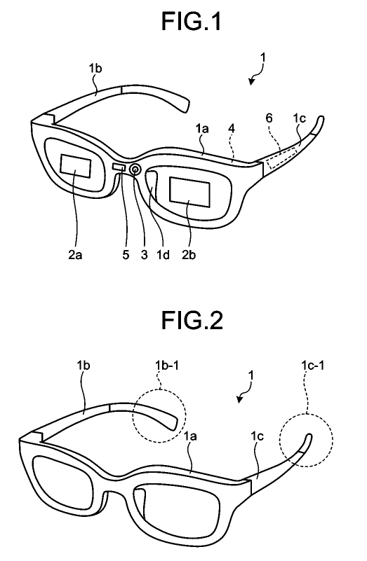

FIG. 1 is a view of a schematic configuration of a head mount display according to embodiments. As illustrated in FIG. 1, a head mount display 1 has a spectacle shape, and includes a front part 1a, a temple part 1b, a temple part 1c, and a support part 1d. The shape of the head mount display 1 illustrated in FIG. 1 is only one example, and is not limited to the shape illustrated in FIG. 1, as long as the head mount display 1 can achieve a function as a wearable device configured to be mounted to a head.

The front part 1a is formed to at least partially surround outer peripheral parts of a display 2a and a display 2b. The front part 1a is formed as a part positioned in front of eyes of the user of the head mount display 1 when the user wears the head mount display 1. The support part 1d includes a pair of support parts 1d (not illustrated), and when the user of the head mount display 1 wears the head mount display 1, the support parts 1d makes contact with the user's nose so that the nose is held therebetween. The support parts 1d contribute to supporting the head mount display 1 worn by the user so that an attitude of the worn head mount display 1 is maintained as much as possible without being displaced along the user's face in a direction of gravitational force.

An imager 3, an imager 4, a detector 5, and an operation unit 6, and the like are also positioned at the front part 1a. The components or the like positioned at the front part 1a illustrated in FIG. 1 are only one example, and are not limited to the example illustrated in FIG. 1.

The temple part 1b and the temple part 1c have a similar rod shape. When the user of the head mount display 1 wears the head mount display 1, the temple part 1b and the temple part 1c are respectively positioned along sides of the user's head. One end of the temple part 1b and one end of the temple part 1c are respectively formed as areas foldably connected to the front part 1a through hinges (not illustrated). The other end of the temple part 1b and the other end of the temple part 1c are respectively formed as areas applied to ears of the user of the head mount display 1, when the user wears the head mount display 1. The temple part 1b and the temple part 1c also contribute to supporting the head mount display 1 worn by the user so that the attitude of the worn head mount display 1 is maintained as much as possible without being displaced along the user's face in the direction of gravitational force, similarly to the support parts 1d.

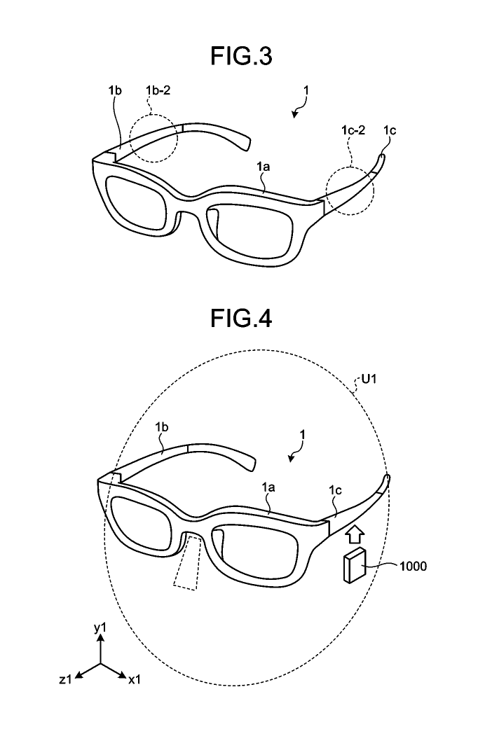

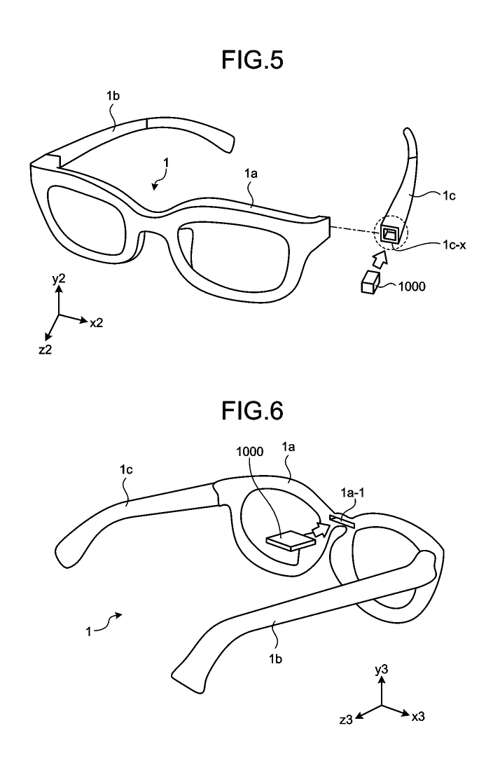

Using FIGS. 2 to 6, examples of a positioning location and an opening direction of an interface of a head mount display will be described below. FIGS. 2 and 3 are views illustrating examples of a positioning location of an interface according to embodiments. FIG. 4 is a view illustrating an example of an opening direction of an interface according to embodiments. FIGS. 5 and 6 are views illustrating other examples of a positioning location and an opening direction of an interface according to embodiments. Though not specifically illustrated in FIGS. 2 to 6, the head mount display 1 includes the interface connecting a cartridge 1000.

As illustrated in FIG. 2, in the head mount display 1, the interface can be positioned at a part 1b-1 near an end of the end parts of the temple part 1b, not connected to the front part 1a, and a part 1c-1 near an end of the end parts of the temple part 1c, not connected to the front part 1a. Alternatively, as illustrated in FIG. 3, in the head mount display 1, the interface can be positioned at a part 1b-2 near a center of the temple part 1b, and a part 1c-2 near a center of the temple part 1c. In the head mount display 1, for example, when the front part 1a including the imager 3, the imager 4, the detector 5, the operation unit 6, and the like, is heavier than the temple parts 1b and 1c, the cartridge 1000 is connected to the temple part 1b (or temple part 1c), and the temple part 1b (or 1c) can have a weight closer to a weight of the front part 1a, and fit can be improved.

When the interface is positioned at the temple part 1b and the temple part 1c, the interface opens vertically downward, while the head mount display 1 is worn by the user U1 (see FIG. 4) of the head mount display 1. Owing to such a configuration, in the head mount display 1, dust or the like is prevented from entering an opening part (outwardly opening part) of the interface.

Using FIG. 4, the opening direction of the interface will be described. An x1 axis, a y1 axis, and a z1 axis of coordinate axes illustrated in FIG. 4 are orthogonal to each other. In the example illustrated in FIG. 4, the front part 1a of the head mount display 1 has a longitudinal direction coinciding with a direction parallel with a direction of the x1 axis of the coordinate axes illustrated in FIG. 4. The interface opens in a direction in which the cartridge 1000 is connectably inserted into the head mount display 1. In the example illustrated in FIG. 4, the interface opens for example vertically downward, that is, in a direction parallel with a negative direction of the y1 axis, though not clearly illustrated in FIG. 4.

As illustrated in FIGS. 2 and 3, the head mount display 1 may be configured to position the interface at the temple part 1b and the temple part 1c, or at any of the temple part 1b and the temple part 1c.

Using FIG. 5, another example of the positioning location and the opening direction of the interface will be described. An x2 axis, a y2 axis, and a z2 axis of coordinate axes illustrated in FIG. 5 are orthogonal to each other. In the example illustrated in FIG. 5, the front part 1a of the head mount display 1 has a longitudinal direction coinciding with a direction parallel with a direction of the x2 axis of the coordinate axes illustrated in FIG. 5. As illustrated in FIG. 5, in the head mount display 1, the interface can be also positioned in a joint part 1c-x of the temple part 1c, located at a position where the temple part 1c fully opened makes contact with the front part 1a. The interface opens to connectably receive insertion of the cartridge 1000. The example of FIG. 5 illustrates a state in which the interface opens in a direction parallel with a positive direction of the z2 axis of the coordinate axes illustrated in FIG. 5. Owing to such a configuration, the head mount display 1 is configured so that when the temple part 1c is fully opened, the opening part of the interface is closed by the front part 1a, and thus, the cartridge 1000 can be protected from an external impact or the like.

In the example illustrated in FIG. 5, the head mount display 1 may be defined to have the opening part opening in a longitudinal direction of the temple part 1b (or temple part 1c), in the temple part 1b (or temple part 1c).

Using FIG. 6, another example of the positioning location and the opening direction of the interface will be described. An x3 axis, a y3 axis, and a z3 axis of coordinate axes illustrated in FIG. 6 are orthogonal to each other. In the example illustrated in FIG. 6, the front part 1a of the head mount display 1 has a longitudinal direction coinciding with a direction parallel with a direction of the x3 axis of the coordinate axes illustrated in FIG. 6. As illustrated in FIG. 6, in the head mount display 1, the interface can be positioned in an area 1a-1 of the front part 1a, opposed to the user's face. The interface opens to connectably receive insertion of the cartridge 1000. The example of FIG. 6 illustrates a state in which the interface opens in a direction parallel with a positive direction of the z3 axis of the coordinate axes illustrated in FIG. 6. Owing to such a configuration, the head mount display 1 can protect the cartridge 1000 from an external impact or the like, while the cartridge 1000 is connected to the interface.

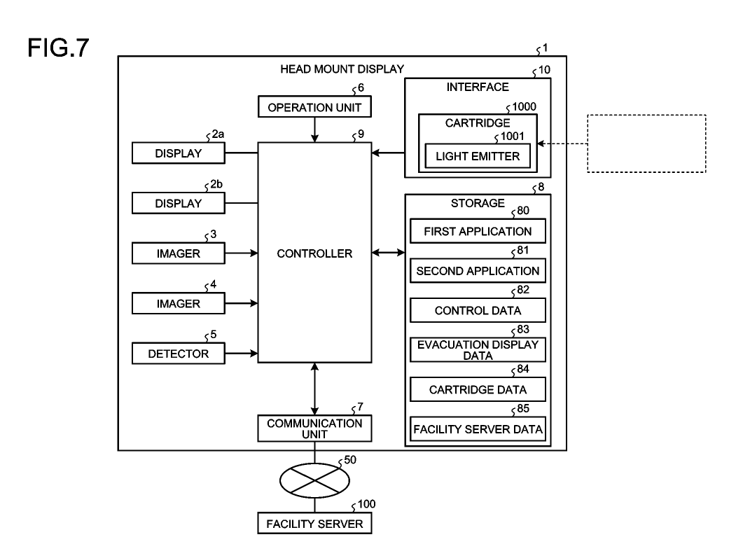

FIG. 7 is a block diagram illustrating an example of a functional configuration of a head mount display according to embodiments. As illustrated in FIG. 7, the head mount display 1 includes the display 2a, the display 2b, the imager 3, the imager 4, the detector 5, the operation unit 6, a communication unit 7, a storage 8, a controller 9, and an interface 10.

The display 2a and the display 2b can have a semi-transmissive or transmissive display device such as a liquid crystal display or an organic electro-luminescence (EL) panel. The display 2a and the display 2b display various information according to a control signal input from the controller 9. The display 2a and the display 2b may be a projector projecting an image on a retina of the user, using a light source such as a laser beam.

The imager 3 and the imager 4 use an image sensor such as a charge coupled device (CCD) image sensor or a complementary metal oxide semiconductor (CMOS) to electronically capture an image. The imager 3 and the imager 4 convert the captured image to a signal, and outputs the signal to the controller 9. The imager 3 is for example a back camera imaging a foreground in front of the user wearing the head mount display 1. The imager 4 is for example a front camera imaging the user wearing the head mount display 1.

The detector 5 performs various detection. The detector 5 uses at least one of visible light, infrared light, ultraviolet light, electric wave, sound wave, magnetism, and capacitance to detect an object to be detected and change in state of the object to be detected. The object to be detected includes a stationary object, a moving object, a living object, and a non-living object. In embodiments, the detector 5 can detect information used for determining whether the head mount display 1 is worn by the user of the head mount display 1. The detector 5 outputs the information used for determining whether the head mount display 1 is worn by the user of the head mount display 1, to the controller 9.

The operation unit 6 receives input of operation such as change in various settings including activation, deactivation, and operation setting of the head mount display 1, from the user. The operation unit 6 converts the input operation received from the user to a signal, and outputs the signal to the controller 9.

The communication unit 7 can perform communication with another device. The communication unit 7 can use for example a predetermined communication protocol to transmit and receive, through a communication network 50, various information transmitted to or received from a facility server 100 in a facility or the like. The communication unit 7 can support one or more near field communication standards. The near field communication standard includes, for example, IEEE802.11, Bluetooth (registered trademark), infrared data association (IrDA), near field communication (NFC), and wireless personal area network (WPAN).

The storage 8 stores a code and data. The code stored in the storage 8 includes a first application 80, and a second application 81. The data stored in the storage 8 includes control data 82, evacuation display data 83, cartridge data 84, and facility server data 85.

The storage 8 may be used as a work area for temporal storage of a result of processing by the controller 9. The storage 8 may include an arbitrary non-transitory storage medium such as a semiconductor storage medium or a magnetic storage medium. The storage 8 may include a plurality of kinds of storage mediums. The storage 8 may include a combination of a storage medium such as a memory card, an optical disk, or a magnetooptical disk, and a reader for the storage medium. The storage 8 may include a storage device used as a temporal storage area such as a random access memory (RAM). The code stored in the storage 8 may include a code (not illustrated) supporting the operation of the application. The code, application, and data stored in the storage 8 may be acquired from another device such as a facility server 100 through wireless or wired communication.

The first application 80 provides functions relating to various controls of the head mount display 1. The first application 80 provides a function for executing the first application 80, on the basis of data acquired from outside. For example, the first application 80 provides a function for acquiring data from the cartridge 1000, and performing processing based on the data, when the cartridge 1000 is connected to the interface 10. The functions provided by the first application 80 include the following functions, in addition to the function described above. The functions provided by the first application 80 include, for example, a function for the user of the head mount display 1 to use equipment items and devices installed in the facility, through the head mount display 1, functions of performing various controls of the head mount display 1, on the basis of a detection result from the detector 5, a function for controlling display on the display 2a and the display 2b, and a function for detecting connection of the cartridge 1000 to the interface 10. The first application 80 may be acquired from the cartridge 1000 connected to the interface 10.

The second application 81 is executed during execution of the first application 80, upon reception of emergency information through the communication unit 7. The second application 81 provides a function of displaying evacuation information on the display 2a and the display 2b, after a non-display state in which no information is displayed on the display 2a and the display 2b. The emergency information includes for example notification of a fire or early warning of earthquake, tsunami, or the like. The non-display state may include a state in which there is no image displayed on the display 2a and the display 2b, and the user of the head mount display 1 can visually recognize a foreground through the display 2a and the display 2b, or a blackout state of the display 2a and the display 2b.

Functions provided by the second application 81 include a function for displaying information representing inhibition of removal of the head mount display 1 on the display 2a and the display 2b, at predetermined appropriate time during a period from reception of the emergency information to display of the evacuation information on the display 2a and the display 2b. The functions provided by the second application 81 include a function for performing processing of making a predetermined notification to the outside through the cartridge 1000, when emergency information is received during execution of the first application. The predetermined notification to the outside includes emitting light from a light emitter 1001 included in the cartridge 1000. The second application 81 may be acquired from the cartridge 1000 connected to the interface 10.

The control data 82 is data used for various controls of the head mount display 1, performed by the functions provided by the first application 80.

The evacuation display data 83 is used for processing by the functions provided by the second application. The evacuation display data 83 includes data for displaying information such as evacuation recommendation, a floor map, and evacuation guidance on the display 2a and the display 2b. The information about the evacuation recommendation includes the contents of a disaster, evacuation instruction, and the like. The floor map includes information such as a current position of the user, an evacuation route, an emergency exit, and a disaster location. The information about the evacuation guidance includes information indicating a movement direction to the emergency exit to the user.

The cartridge data 84 is data acquired from the cartridge 1000 connected to the interface 10. The cartridge data 84 includes first application reference data and the like. The first application reference data is used in processing performed by the first application 80. For example, in case of an amusement arcade, the first application reference data is used so that the first application 80 outputs content such as a moving image or sound to the head mount display 1, according to the progress of a game in an attraction. When the first application reference data is formed as an application set including applications respectively corresponding to the equipment items and devices installed in the facility, the first application reference data may be formed as a data set including data corresponding to each application.

The facility server data 85 is data provided from the facility server 100. For example, in case of an amusement arcade, the facility server data 85 is used for the first application 80 to display various information about the amusement arcade other than that acquired from the cartridge 1000, on the head mount display 1.

The controller 9 includes a calculation processor. The calculation processor may include for example a central processing unit (CPU), a system-on-a-chip (SoC), a micro control unit (MCU), a field-programmable gate array (FPGA), and a coprocessor, but is not limited to a configuration including them. The controller 9 integrally controls operation of the head mount display 1 to achieve various functions. Specifically, the controller 9 executes a command included in the first application 80 or the second application 81 stored in the storage 8, while referring to the control data 82 stored in the storage 8 if necessary, and achieves various controls of the head mount display 1.

When the controller 9 executes the first application 80 and for example the cartridge 1000 is connected to the interface 10, data is acquired from the cartridge 1000, and processing is performed on the basis of the data. The controller 9 executes the second application 81, in order to perform processing of displaying the evacuation information on the display 2a and the display 2b, after the non-display state in which no information is displayed on the display 2a and the display 2b, when receiving emergency information through the communication unit 7 during execution of the first application 80. The controller 9 executes the second application 81, in order to perform processing of displaying information representing inhibition of removal of the head mount display 1, on the display 2a and the display 2b, at the predetermined appropriate time during the period from reception of the emergency information to display of the evacuation information on the display 2a and the display 2b. The controller 9 executes the second application 81, in order to perform processing of causing the cartridge 1000 to make a predetermined notification to the outside, when receiving emergency information during execution of the first application.

The interface 10 opens to allow connection of the cartridge 1000. When the cartridge 1000 is connected, the interface 10 outputs, to the controller 9, a connection detection signal for notifying the controller 9 of connection of the cartridge. The interface 10 acquires data stored in the cartridge 1000 from the cartridge 1000, and outputs the acquired data to the controller 9.

The cartridge 1000 has the light emitter 1001. The light emitter 1001 emits light according to the control signal transmitted from the controller 9.

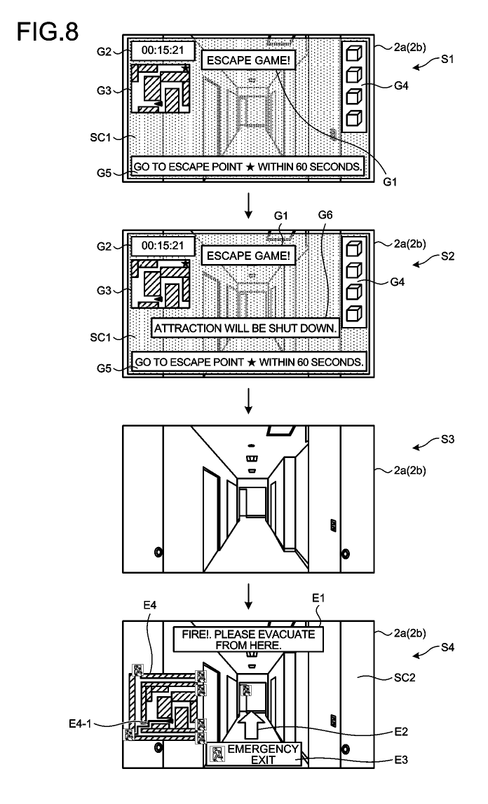

Using FIG. 8, an example of the processing performed by the controller 9 will be described. FIG. 8 is a diagram illustrating an example of the processing by a controller according to embodiments. FIG. 8 illustrates the example of processing performed when a fire occurs while the user of the head mount display 1 plays a game in an attraction of an amusement arcade.

As illustrated in FIG. 8, the controller 9 executes the first application 80 in order to display a game screen SC1 corresponding to the attraction, on the display 2a and the display 2b, on the basis of attraction data acquired from the cartridge 1000 (Step S1). The game screen SC1 includes images corresponding to a plurality of sets of information G1 to G5 relating to the attraction being performed.

When emergency information is received during execution of the first application 80, that is, during a game corresponding to the attraction, the controller 9 displays a message image G6 representing shut-down of the first application 80 being executed, on the game screen SC1 (Step S2), and shuts down the first application 80 being executed.

Next, the controller 9 executes the second application, clears the game screen SC1 being displayed on the display 2a and the display 2b, and displays a screen SC2 including the evacuation information, on the display 2a and the display 2b (Step S4), after the non-display state in which no information is displayed on the display 2a and the display 2b (Step S3). In an example described in Step S3, the game screen SC1 being displayed on the display 2a and the display 2b is erased into the non-display state in which no information is displayed on the display 2a and the display 2b, and a foreground in front of the user of the head mount display 1 can be visually recognized through the display 2a and the display 2b. In an example described in Step S4, the screen SC2 displays information E4-1 representing the contents of a disaster and evacuation instruction, a floor map E4 including information E4-1 representing an evacuation route from a current position of the user, and information E2 and E3 about evacuation guidance.

In the processing of Step S3 and Step S4, the controller 9 keeps displaying the non-display state in which no information is displayed on the display 2a and the display 2b, described in Step S3, for a certain time period, and then displays the screen SC2 described in Step S4, on the display 2a and the display 2b. Duration of the non-display state may be an arbitrary time period, as long as the arbitrary time period has a sufficient length to bring the user of the head mount display 1, focusing on the attraction, back to the real world in which the emergency occurs.

The controller 9 starts lighting of the light emitter 1001 of the cartridge 1000, in cooperation with displaying the screen SC2 including the evacuation information on the display 2a and the display 2b. When power failure is caused or the user is in a darkened environment due to the emergency, the light emitter 1001 of the cartridge 1000 is lit, and the cartridge 1000 serves as an emergency lamp.

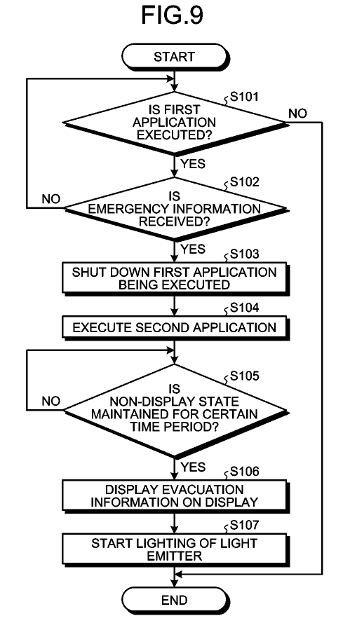

Using FIG. 9, a flowchart of processing performed by the head mount display 1 according to embodiments will be described. FIG. 9 is a flowchart illustrating an example of the processing performed by the head mount display 1 according to embodiments.

As illustrated in FIG. 9, the head mount display 1 determines whether the first application 80 is executed (Step S101).

As a result of the determination, when the first application 80 is not executed (Step S101, No), the head mount display 1 terminates the processing illustrated in FIG. 9.

In contrast, as a result of the determination, when the first application 80 is executed (Step S101, Yes), the head mount display 1 determines whether the emergency information is received (Step S102).

As a result of the determination, when the emergency information is not received (Step S102, No), the head mount display 1 returns the process to Step S101.

In contrast, as a result of the determination, when the emergency information is received (Step S102, Yes), the head mount display 1 shuts down the first application 80 being executed (Step S103), and executes the second application 81 (Step S104).

Then, after shut-down of the first application 80 being executed, the head mount display 1 determines whether the non-display state in which no information is displayed on the display 2a and the display 2b is maintained for a certain time period (Step S105).

As a result of the determination, when the non-display state is not maintained for the certain time period (Step S105, No), the head mount display 1 repeats the determination in Step S105.

In contrast, as a result of the determination, when the non-display state is maintained for the certain time period (Step S105, Yes), the head mount display 1 displays the evacuation information on the display 2a and the display 2b (Step S106).

Then, the head mount display 1 starts lighting of the light emitter 1001 of the cartridge 1000 (Step S107), and terminates the processing illustrated in FIG. 9.

In embodiments, when receiving emergency information, the head mount display 1 shuts down the first application 80 being executed to execute the second application 81, and displays the screen SC2 including the evacuation information on the display 2a and the display 2b, after the non-display state in which no information is displayed on the display 2a and the display 2b. Therefore, the user of the head mount display 1 can quickly perceive occurrence of an emergency, even while the user receives provision of various services through the head mount display to which the cartridge 1000 is connected, and thus usability of the head mount display 1 when using a facility providing the cartridge 1000 can be improved.

In embodiments, the example has been described in which when receiving emergency information, the head mount display 1 shuts down the first application 80 being executed to execute the second application 81, and displays the screen SC2 including the evacuation information on the display 2a and the display 2b, after the non-display state in which no information is displayed on the display 2a and the display 2b. However, the head mount display is not limited to this example, and may display a predetermined screen instead of the non-display state. The head mount display 1 displaying the predetermined screen will be described below.

The head mount display 1 according to other embodiments basically has a configuration similar to those of embodiments, but is different therefrom in points described below.

The second application 81 provides a function of displaying the evacuation information on the display 2a and the display 2b, after a state in which the predetermined screen not associated with the first application 80 is displayed on the display 2a and the display 2b. The predetermined screen may be for example an arbitrary screen set by the user of the head mount display 1, in addition to a start screen displayed upon activation of the head mount display 1.

The controller 9 executes the second application 81, in order to perform processing of displaying the evacuation information on the display 2a and the display 2b, after a state in which the predetermined screen not associated with the first application 80 is displayed on the display 2a and the display 2b.

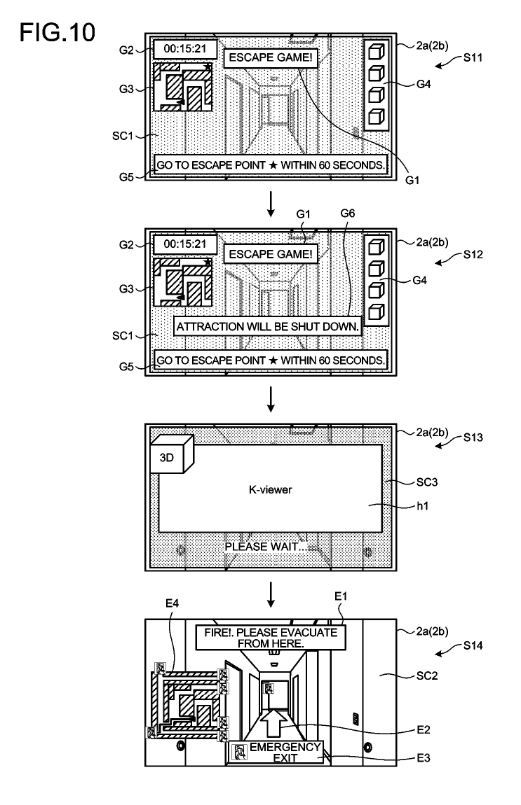

Using FIG. 10, an example of processing performed by the controller 9 will be described. FIG. 10 is a diagram illustrating an example of processing by a controller according to other embodiments. The example of processing of FIG. 10, described below, is different from the processing of FIG. 9, described above, in processing of Step S13.

As illustrated in FIG. 10, the controller 9 executes the first application 80 in order to display the game screen SC1 corresponding to the attraction, on the display 2a and the display 2b, on the basis of attraction data acquired from the cartridge 1000 (Step S11).

When emergency information is received during execution of the first application 80, that is, during a game corresponding to the attraction, the controller 9 displays the message image G6 representing shut-down of the first application 80 being executed, on the game screen SC1 (Step S12), and shuts down the first application 80 being executed.

Next, the controller 9 executes the second application 81, clears the game screen SC1 being displayed on the display 2a and the display 2b, and displays the screen SC2 including the evacuation information, on the display 2a and the display 2b (Step S14), after a state in which a start screen SC3 including an image h1 is displayed on the display 2a and the display 2b (Step S13).

In the processing of Step S3 and Step S4, the controller 9 keeps displaying the state in which the start screen SC3 is displayed on the display 2a and the display 2b, for a certain time period, and then displays the screen SC2 described in Step S4, on the display 2a and the display 2b. Duration of display of the start screen SC3 may be an arbitrary time period, as long as the arbitrary time period has a sufficient length to bring the user of the head mount display 1, focusing on the attraction, back to the real world in which the emergency occurs.

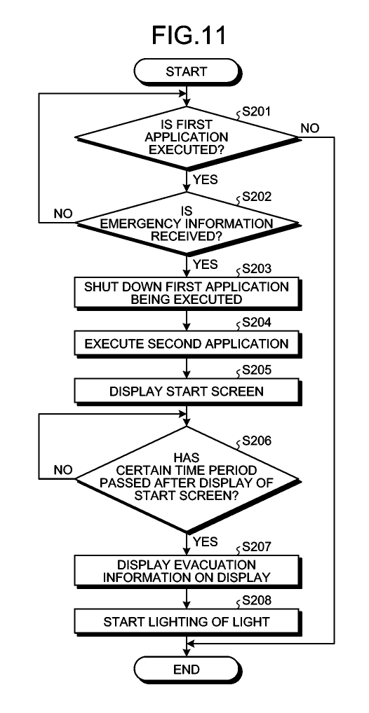

Using FIG. 11, a flowchart of processing performed by the head mount display 1 according to other embodiments will be described. FIG. 11 is a flowchart illustrating an example of the processing performed by the head mount display 1 according to other embodiments.

As illustrated in FIG. 11, the head mount display 1 determines whether the first application 80 is executed (Step S201).

As a result of the determination, when the first application 80 is not executed (Step S201, No), the head mount display 1 terminates the processing illustrated in FIG. 11.

In contrast, as a result of the determination, when the first application 80 is executed (Step S201, Yes), the head mount display 1 determines whether the emergency information is received (Step S202).

As a result of the determination, when the emergency information is not received (Step S202, No), the head mount display 1 returns the process to Step S201.

In contrast, as a result of the determination, when the emergency information is received (Step S202, Yes), the head mount display 1 shuts down the first application 80 being executed (Step S203), and executes the second application 81 (Step S204).

Then, the head mount display 1 displays the start screen on the display 2a and the display 2b (Step S205).

After display of the start screen, the head mount display 1 determines whether the certain time period has passed after the display of the start screen (Step S206).

As a result of the determination, when the certain time period has not passed after the display of the start screen (Step S206, No), the head mount display 1 repeats the determination in Step S206.

In contrast, as a result of the determination, when the certain time period has passed after the display of the start screen (Step S206, Yes), the head mount display 1 displays the evacuation information on the display 2a and the display 2b (Step S207).

Then, the head mount display 1 starts lighting of the light emitter 1001 of the cartridge 1000 (Step S208), and terminates the processing illustrated in FIG. 11.

In embodiments, when receiving emergency information, the head mount display 1 shuts down the first application 80 being executed to execute the second application 81, and displays the screen SC2 including the evacuation information on the display 2a and the display 2b, after the state in which the start screen SC3 is displayed on the display 2a and the display 2b. Therefore, the user of the head mount display 1 can quickly perceive occurrence of an emergency, even while the user receives provision of various services through the head mount display to which the cartridge 1000 is connected, and thus usability of the head mount display 1 when using a facility providing the cartridge 1000 can be improved.

In embodiments, when receiving emergency information, the head mount display 1 may notify the user of warning against removal of the head mount display 1 upon shutting down the first application 80 being executed and execution of the second application 81. The notification of warning against removal of the head mount display 1 may be performed by sound or image.

In embodiments, the examples of various processing achieved by executing the first application 80 and the second application 81 by the controller 9 of the head mount display 1 are described, but achievement of various processing is not limited thereto. For example, the first application 80 and the second application 81 may be integrated into one code providing the functions of the codes. In this configuration, the controller 9 executes the one code providing the functions of the first application 80 and the second application 81, and the various processing according to embodiments can be achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A head mount display comprising:
a display;
a communication unit; and
a controller configured to execute a first application on the basis of data acquired from outside,
wherein when receiving emergency information through the communication unit during execution of the first application, the controller is configured to execute a second application for displaying evacuation information on the display, after a non-display state in which information is not displayed on the display.

2. The head mount display according to claim 1, wherein
the second application executed by the controller includes processing of displaying information representing inhibition of removal of the head mount display on the display, at predetermined appropriate time during a period from reception of the emergency information to display of the evacuation information on the display.

3. The head mount display according to claim 1 further comprising
an interface configured to connect a cartridge thereto,
wherein the first application executed by the controller includes
a function for acquiring the data from the cartridge, and performing processing based on the data, when the cartridge is connected to the interface, and
the second application executed by the controller includes
a function for causing the cartridge to make a predetermined notification to the outside, when receiving emergency information during execution of the first application.

4. A head mount display comprising:
a display;
a communication unit; and
a controller configured to execute a first application on the basis of data acquired from outside,
wherein when receiving emergency information through the communication unit during execution of the first application, the controller is configured to execute a second application for displaying evacuation information on the display, after a predetermined screen not associated with the first application is displayed on the display.

5. The head mount display according to claim 4, wherein
the second application executed by the controller includes processing of displaying information representing inhibition of removal of the head mount display on the display, at predetermined appropriate time during a period from reception of the emergency information to display of the evacuation information on the display.

6. The head mount display according to claim 4 further comprising
an interface configured to connect a cartridge thereto,
wherein the first application executed by the controller includes
a function for acquiring the data from the cartridge, and performing processing based on the data, when the cartridge is connected to the interface, and
the second application executed by the controller includes
a function for causing the cartridge to make a predetermined notification to the outside, when receiving emergency information during execution of the first application.
